(19) United States
(12) Patent Application Publication
(10) Pub. No.: US 2009/0227123 A1
(43) Pub. Date: Sep. 10, 2009

(54) Connectorized alarm cross connect panel

(75) Inventors: Armin Paya, Plano, TX (US); Jay H. Dorval, Lucas, TX (US); Richard J. Doyle, Rowlett, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Bedford, Inc., Naperville, IL (US)

(21) Appl. No.: 12/075,018

(22) Filed: Mar. 7, 2008

(51) Int. Cl. H01R 29/00

(52) U.S. Cl. 439/49

(57) ABSTRACT

Disclosed are an apparatus and corresponding method for a cross connect panel that includes a circuit board, a trace, and a cross connect field of user-configurable assignment terminals. The circuit board is equipped with input and output connectors and a trace that is connected to a first subset of equipment terminals on the input and output connectors. The cross connect field allows a user to cross connect selectively a second subset of the equipment terminals on the input and output connectors. The input and output connectors may include wire wrap pins (e.g., pre-manufactured and connectorized by a machine). The input/output connectors may be connected to alarm generating and alarm monitoring/status transport devices. Employing an embodiment of the present invention increases reliability, reduces chances of miswiring, and decreases time/labor during system integration and diagnosis.

### BACKGROUND OF THE INVENTION

In the telecommunications industry, cross connect panels have been used to connect components. Typical alarm aggregation and cross connect panels use a manual wire wrap termination, which is extremely labor intensive, time consuming, unreliable and prone to miswiring during system integration. Manual, semiautomatic, and automatic wire wrapping techniques may be used. Prior approaches utilized in the telecommunication industry involve a pinfield matrix and wire wrap terminations. Wire wrap terminations are used to develop electronic assemblies.

### SUMMARY OF THE INVENTION

The summary that follows describes some of the example embodiments included in this disclosure. The information is proffered to provide a fundamental level of comprehension of aspects of this disclosure.

An example embodiment of the present invention may include apparatus and corresponding method for a cross connect panel. The cross connect panel may include a circuit board, trace, and cross connect field of user-configurable assignment terminals. The circuit board may be configured with input connectors and output connectors on an equipment side of the circuit board. The trace on the circuit board may be connected to a first subset of equipment terminals on the input and output connectors, which provides a reference to the first subset of the equipment terminals. The cross connect field may be on a user side of the circuit board and allow a user to cross connect selectively a second subset of the equipment terminals on the input connectors and output connectors.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a high level diagram of a system employing a cross connect panel.

FIGS. 1B and 1C are prospective views of a connectorized alarm cross connect panel in accordance with an example embodiment of the present invention.

FIGS. 2A-2D are schematic diagrams of a circuit side, component side, and trace of a circuit board in accordance with an example embodiment of the present invention.

FIGS. 3A and 3B are block diagrams illustrating a method to cross connect a panel in accordance with an example embodiment of the present invention.

### DETAILED DESCRIPTION OF THE INVENTION

A description of example embodiments of the invention follows.

With the wire wrap technique used in current practice, discrete alarm wires are run from multiple shelves to a pinfield. At the pinfield, wires are cross connected by wire wrap into appropriate groups (e.g., power alarms, signal alarms, etc.).

In contrast, example embodiments of the present invention allow for cable assemblies to be pre-manufactured and connectorized by a machine. Doing so may create a perfect seal between wires and connectors, which results in long-term reliability. Once the shelves are installed, the cable assembles may be run from each shelf to an alarm cross connection. An intermediate connector shroud may allow for the grouping of alarms regardless of the shelf or physical location from which an alarm is generated. The following are example advantages provided by certain aspects of the present invention: (i) increase in connection reliability, (ii) elimination of the possibility of miswiring, (iii) allows the use of machine-terminated or pre-made cable assemblies that may be connectorized on each end, (iv) decreased time required during system integration and diagnosis, and (v) decreased labor required during system integration and diagnosis.

An example embodiment of the present invention may include apparatus and corresponding method for a cross connect panel. The cross connect panel may include a circuit board, a trace, and a cross connect field of user-configurable assignment terminals. The circuit board may be configured with input connectors and output connectors on an equipment side of the circuit board. The trace on the circuit board may be connected to a first subset of equipment terminals on the input connectors and output connectors, which provides a reference to the first subset of the equipment terminals. The cross connect field may be on a user side of the circuit board and may allow a user to cross connect selectively a second subset of the equipment terminals on the input connectors and output connectors.

The second subset of the equipment terminals may be configured to be cross connected in at least one of the following exemplary manners: mechanical, electro-mechanical, electrical, and opto-electrical. The input connectors and output connectors may include wire wrap pins.

In another example embodiment, the input connector may be connected to an equipment monitoring device configured to generate an alarm signal. The output connector may be connected to an equipment status transport device. The cross connect field may be configured to route an alarm signal transmitted by the equipment monitoring device to the equipment status transport device, which may be configured to report the alarm signal to a management node or to generate an alarm signal.

An example embodiment of the present invention may have user-configurable assignment terminals that provide more connection points with a larger pitch than user-configurable assignment terminals in an absence of the input connectors, output connectors, and trace.

In another example embodiment, the cross connect panel may be mounted in an enclosure with other equipment that includes devices electrically configured to connect pairs of the first subset of terminals with the reference to the first subset of the equipment terminals and a reference wire connected to the trace and the enclosure. The enclosure may include an electrical ground reference node, and the reference wire may be connected to the electrical ground reference node.

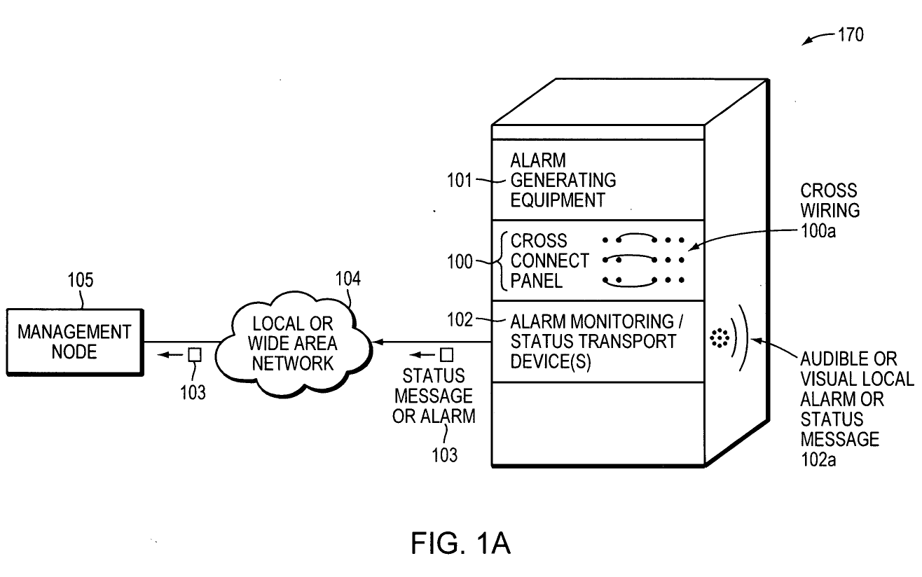

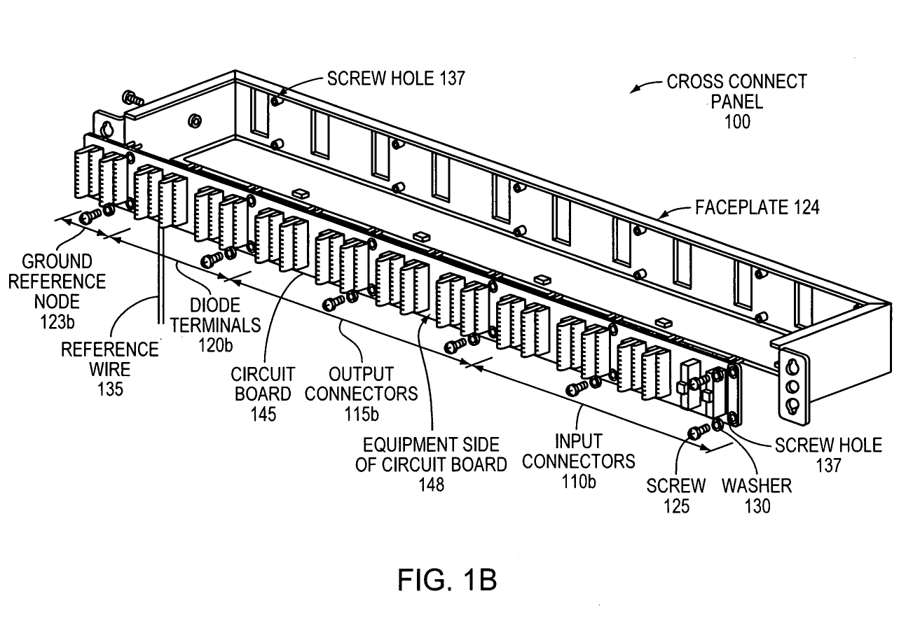

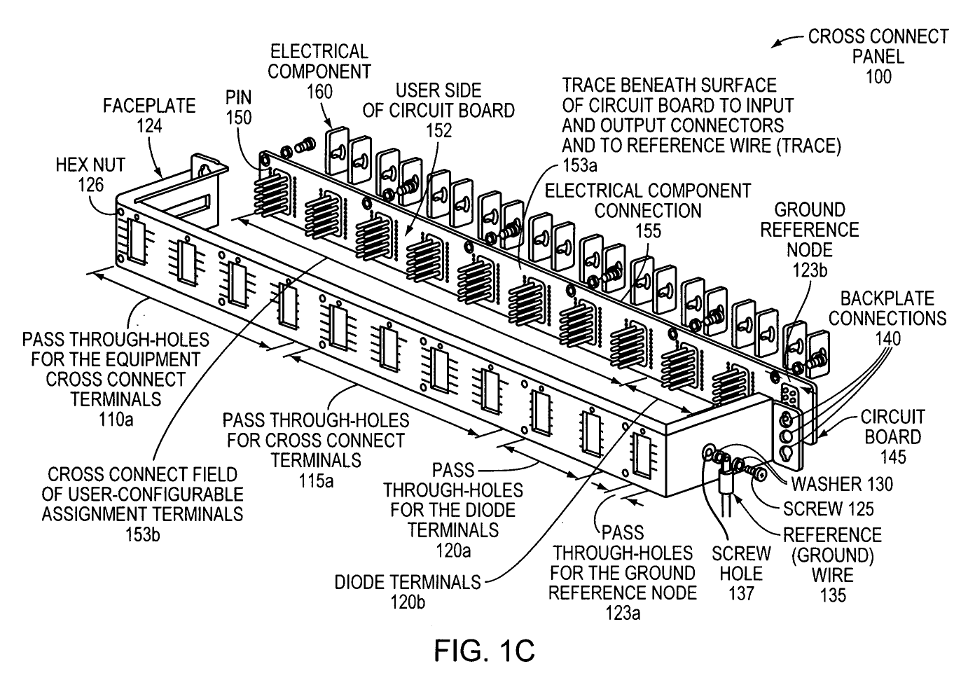

FIGS. 1A-1C are illustrations of a connectorized alarm cross connect panel 100 in accordance with an example embodiment of the present invention. FIG. 1A is a high level diagram of a system 170 employing a cross connect panel 100. FIGS. 1B and 1C are prospective views of a connectorized alarm cross connect panel (or cross connect panel) 100 in accordance with an example embodiment of the present invention.

Referring to FIGS. 1A-1C in unison unless otherwise indicated, the cross connect panel 100 may include a circuit board 145, trace 153a, and cross connect field 153b. FIG. 1A is a diagram of a system 170 in which a cross connect panel 100 may be employed. The cross connect panel 100 may be mounted in an enclosure (e.g., shelves) with other equipment, such as alarm generating equipment 101 and alarm (or equipment) monitoring/status transport device 102. The alarm monitoring/status transport device 102 may produce an audible or visual local alarm or status message 102a. The alarm monitoring/status transport device 102 may send a status message or alarm 103 to the local or wide area network 104, which may then direct the status message or alarm 103 to a management node 105. The other equipment may also be electronically configured to connect pairs of the user-configurable assignment terminals 153b with the reference to a second subset of the equipment terminals. The enclosure may also include a reference wire 135 that is connected to the trace 153a and the enclosure 170.

The circuit board 145 may have input connectors 110b and output connectors 115b on an equipment side 148 of the circuit board 145 that allow for cross wiring 100a. The trace 153a on the circuit board 145 may be connected to a first subset of equipment terminals on the input connectors 110b and output connectors 115b to provide a reference to the first subset of the equipment terminals. The cross connect field 153b of user-configurable assignment terminals, in which an electronic component 160 may be inserted on an equipment side 148 of the circuit board 145, allows a user to cross connect selectively a second subset of the equipment terminals on the input connectors 110b and output connectors 115b. The cross connect field of user-configurable assignment terminals 153b may include terminals of a collection of wirewrap pins (pins) 150 that are positioned in alignment with each respective input connector terminals 110b, output connector terminals 115b, and diode terminals 120b. The pins 150 may be configured to receive or transmit low voltages. Cross connecting the second subset of the equipment terminals may be performed in at least one of the following manners: mechanical, electro-mechanical, electrical, and opto-electrical.

The electrical components 160 may provide more connection points with a larger pitch than user-configurable assignment terminals in an absence of the input and output connectors 110b, 115b and trace 153a. The trace 153a may be beneath the surface of the circuit board 145 and configured to provide a reference to a subset of the equipment terminals and the ground reference wire 135.

The cross connect panel 100 may also include a faceplate 124 with pass through-holes for the following: equipment cross connect terminals 110a, cross connect terminals 115a, diode terminals 120a, and ground reference node 123a. The ground reference node is optionally not configured for the insertion of an electrical component 160. The faceplate 124 may be connected (e.g., screw 125, washer 130, and screw hole 137) to a reference (ground) wire 135. The circuit board 145 may be connected to the faceplate 124 using a screw 125, washer 130, screw hole 137, and a hex nut 126. The faceplate 124 may be connected to a backplate (not shown) using backplate connections 140.

The use of screws, washers, and hex nuts is done for exemplary purposes only. Screws, bolts, clasps, or other fasteners and necessary accessories may be used in accordance with an example embodiment of the present invention. The connections between the cross connect panel 100 and any equipment may be done using wires, cable assemblies, or the like in accordance with an example embodiment of the present invention.

The tolerances between the hole centers of each pin 150 may be ±0.005 in., for example. The maximum height of a electrical component 160 (conductive or nonconductive) may be 0.18 in. on the component side 148 of the circuit board 145 and 1.00 in. on the circuit side 152 of the circuit board 145. In this example embodiment, the maximum lead length from the circuit aide 152 of the circuit board 145 is 0.060 in. for leaded components and 0.100 in. for compliant pin connectors.

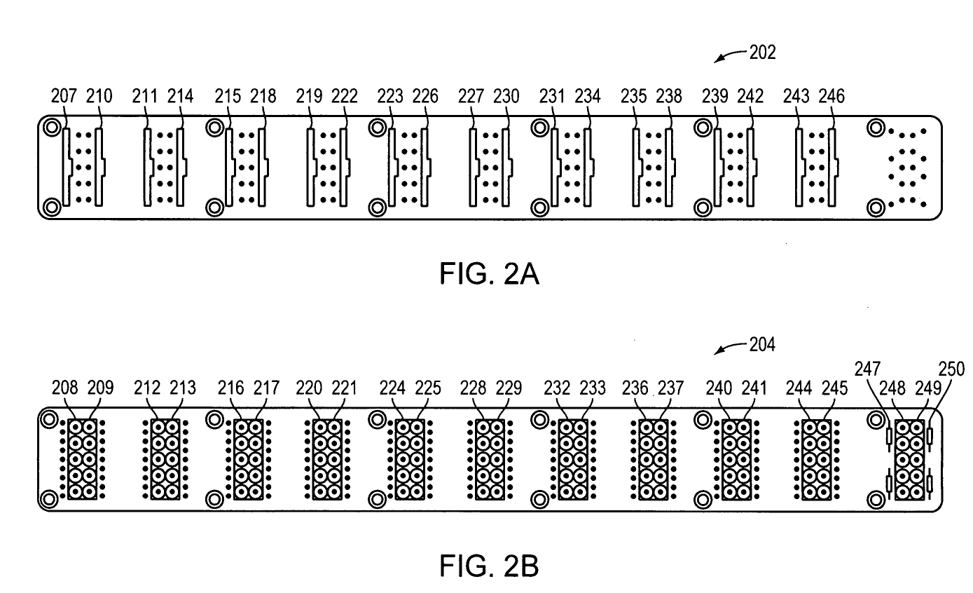

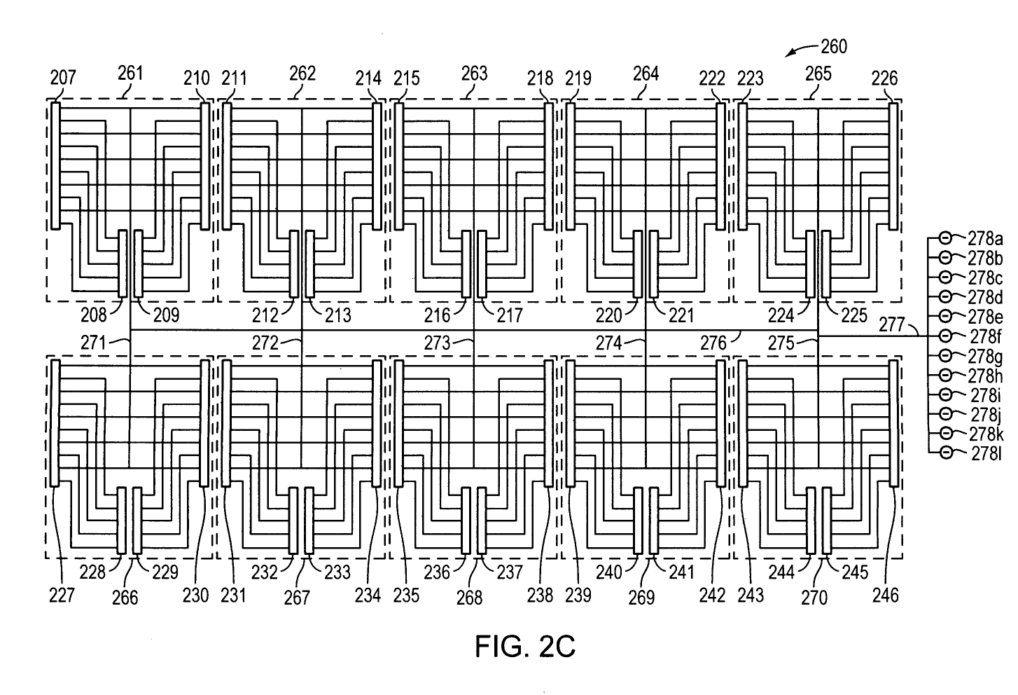

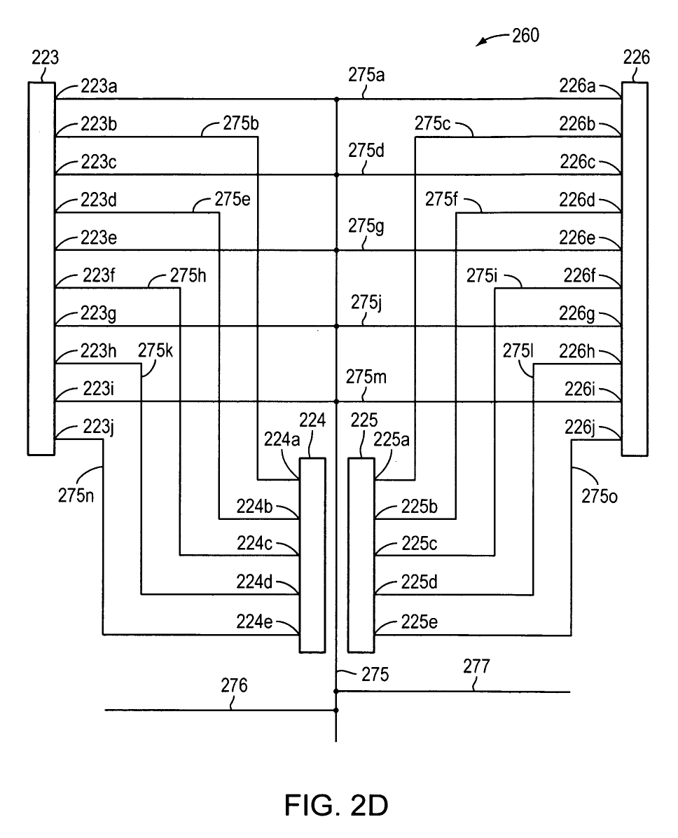

FIGS. 2A-2D are schematic diagrams of a circuit side 202, component side 204, and trace 260 of a circuit board 200 in accordance with an example embodiment of the present invention. Each electrical component (such as electrical component 160 of FIG. 1A) connected to the circuit side 202 of the circuit board 200 may have a corresponding junction 207, 210, 211, 214, 215, 218, 219, 222, 223, 226, 227, 230, 231, 234, 235, 238, 239, 242, 243, 246 connected to the trace 260 on the component side 204 of the circuit board 200. Each column of pins that may be connected to input connectors, output connectors, or diode terminals (such as input connectors 110, output connectors 115, and diode terminals 120 of FIG. 1A) may have a corresponding junction 208, 209, 212, 213, 216, 217, 220, 221, 224, 225, 228, 229, 232, 233, 236, 237, 240, 241, 244, 245, 247, 248, 249, 250 connected to the trace 260 on the component side 204 of the circuit board 200.

The junctions may be grouped, and each group and junction may be connected to several alarm options. Group 1 261 may include four junctions 207, 208, 209, 210. Group 2 262 may include four junctions 211, 212, 213, 214. Group 3 263 may include four junctions 215, 216, 217, 218. Group 4 264 may include four junctions 219, 220, 221, 222. Group 5 265 may include four junctions 223, 224, 225, 226. Group 6 266 may include four junctions 227, 228, 229, 230. Group 7 267 may include four junctions 231, 232, 233, 234. Group 8 268 may include four junctions 235, 236, 237, 238. Group 9 269 may include four junctions 239, 240, 241, 242. Group 10 270 may include four junctions 243, 244, 245, 246.

FIG. 2D is a close-up view of a schematic of Group 5 265 of the trace 205 on the component side 203 of a circuit board in accordance with the present invention. Group 265 includes four junctions 223, 224, 225, 226. The four junctions may be connected in the following manner: pin 1 223a is connected 275a to pin 1 226a, pin 2 223b is connected 275b to pin 1 224a, pin 2 226b is connected 275c to pin 1 225a, pin 3 223c is connected 275d to pin 3 226c, pin 4 223d is connected 275e to pin 2 224b, pin 4 226d is connected 275f to pin 2 225b, pin 5 223e is connected 275g to pin 5 226e, pin 6 223f is connected 275h to pin 3 224c, pin 6 226f is connected 275i to pin 3 225c, pin 7 223g is connected 275j to pin 7 226g, pin 8 224h is connected 275k to pin 4 224d, pin 8 226h is connected 275l to pin 4 225d, pin 9 223i is connected 275m to pin 9 226i, pin 10 223j is connected 275n to pin 4 224e, and pin 10 226j is connected 275o to pin 5 225e. Each group may be configured in accordance with the aforementioned description.

Group 1 261 and Group 6 266 are connected 271 to one another. Group 2 262 and Group 7 267 are connected 272. Group 3 263 and Group 8 268 are connected 273. Group 4 264 and Group 9 269 are connected 274. Group 5 265 and Group 10 270 are connected 275. The group connections 271, 272, 273, 274, 275 are connected 276 to one another and connected 277 to several alarm options 278a-1.

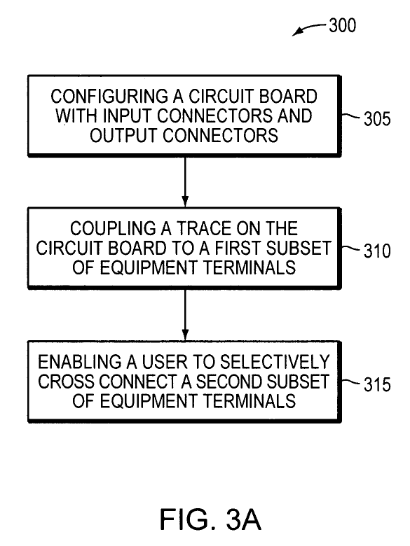

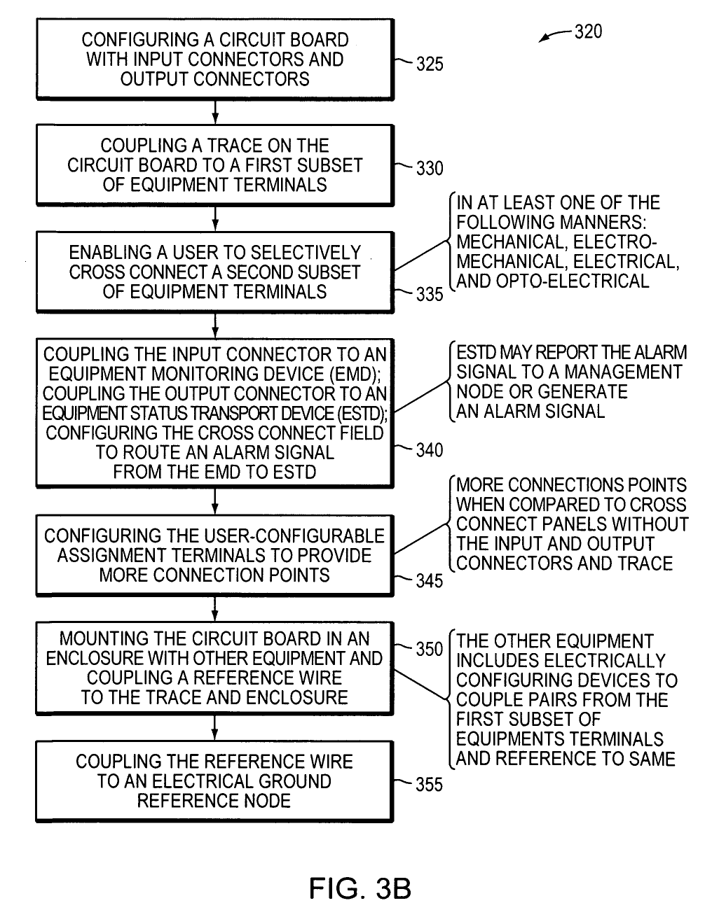

FIGS. 3A and 3B are block diagrams of a method to cross connect a panel in accordance with an example embodiment of the present invention. FIG. 3A is a block diagram illustrating a method 300 that may be employed to cross connect a panel in accordance with an example embodiment of the present invention. First, the circuit board is configured 305 with input connectors and output connectors on an equipment side of the circuit board. Next, a trace is connected 310 on the circuit board to a first subset of equipment terminals on the input connectors and output connectors to provide a reference to the first subset of the equipment terminals. Then, a user may selectively cross connect 315 a second subset of the equipment terminals in a selective manner on the input connectors and output connectors to a cross connect field of user-configurable assignment terminals on a user side of the circuit board.

FIG. 3B is a block diagram of a method 320 that may be employed to cross connect a panel in accordance with an example embodiment of the present invention. The circuit board is configured 325, and the trace is connected 330 on the circuit board as illustrated by FIG. 3A. A user may selectively cross connect 335 a second subset of the equipment terminals in a selective manner on the input connectors and output connectors to a cross connect field of user-configurable assignment terminals on a user side of the circuit board. The user may cross connect the second subset of the equipment terminals in at least one of the following example manners: mechanical, electro-mechanical, electrical, and opto-electrical. Next, the input connector may be connected 340 to an equipment monitoring device (EMD) that is configured to generate an alarm signal, the output connector may be connected to an equipment status transport device (ESTD), and the cross connect field may be configured to route an alarm signal transmitted by the equipment monitoring device to the equipment status transport device, which may report the alarm signal to a management node or generate an alarm signal. Next, the user may configure 345 the user-configurable assignment terminals to provide more connection points with a larger pitch than user-configurable assignment terminals in an absence of the input connectors, output connectors, and trace. Then, the circuit board may be mounted 350 in an enclosure with other equipment, which includes electrically configuring devices to connect pairs of the first subset of the equipment terminals with the reference to the first subset of the equipment terminals, and connecting a reference wire to the trace and the enclosure. A reference wire may also be connected 355 to an electrical ground reference node.

While this invention has been particularly shown and described with references to example embodiments thereof, it will be understood by those skilled in the art that various changes in form and details may be made therein without departing from the scope of the invention encompassed by the appended claims.

What is claimed is:

1. A cross connect panel, comprising:
a circuit board configured with input connectors and output connectors on an equipment side of the circuit board;
a trace on the circuit board coupled to a first subset of equipment terminals on the input connectors and output connectors to provide a reference to the first subset of the equipment terminals; and
a cross connect field of user-configurable assignment terminals on a user side of the circuit board to enable a user to cross connect selectively a second subset of the equipment terminals on the input connectors and output connectors.

2. The cross connect panel as claimed in claim 1 wherein the second subset of the equipment terminals is configured to be cross connected in at least one of the following manners: mechanical, electro-mechanical, electrical, and opto-electrical.

3. The cross connect panel as claimed in claim 1 wherein the input connectors and output connectors include wire wrap pins.

4. The cross connect panel as claimed in claim 1 wherein the input connector is coupled to an equipment monitoring device that is configured to generate an alarm signal, the output connector is coupled to an equipment status transport device, the cross connect field is configured to route an alarm signal transmitted by the equipment monitoring device to the equipment status transport device and wherein the equipment status transport device is configured to report the alarm signal to a management node or to generate an alarm signal.

5. The cross connect panel as claimed in claim 1 wherein the user-configurable assignment terminals provide more connection points with a larger pitch than user-configurable assignment terminals in an absence of the input connectors and output connectors and trace configured to provide a reference to the first subset of equipment terminals.

6. The cross connect panel as claimed in claim 1 mounted in an enclosure with other equipment which includes devices electrically configured to couple pairs of the first subset of equipment terminals with the reference to the second subset of the equipment terminals and a reference wire coupled to the trace and the enclosure.

7. The cross connect panel as claimed in claim 6 wherein the enclosure includes an electrical ground reference node, and wherein the reference wire is coupled to the electrical ground reference node.

8. A method to cross connect a panel, comprising:
configuring a circuit board with input connectors and output connectors on an equipment side of the circuit board;
coupling a trace on the circuit board to a first subset of equipment terminals on the input connectors and output connectors to provide a reference to the first subset of the equipment terminals; and
enabling a user to cross connect a second subset of the equipment terminals in a selective manner on the input connectors and output connectors to a cross connect field of user-configurable assignment terminals on a user side of the circuit board.

9. The method as claimed in claim 8 wherein enabling the user to cross connect the second subset of the equipment terminals includes enabling the user to perform the cross connecting in at least one of the following manners: mechanical, electro-mechanical, electrical, and opto-electrical.

10. The method as claimed in claim 8 further including coupling the input connector to an equipment monitoring device that is configured to generate an alarm signal, coupling the output connector to an equipment status transport device, configuring the cross connect field to route an alarm signal transmitted by the equipment monitoring device to the equipment status transport device and configuring the equipment status transport device to report the alarm signal to a management node or to generate an alarm signal.

11. The method as claimed in claim 8 further including configuring the user-configurable assignment terminals to provide more connection points with a larger pitch than user-configurable assignment terminals in an absence of the input connectors, output connectors, and trace.

12. The method as claimed in claim 8 further including mounting the circuit board in an enclosure with other equipment, which includes electrically configuring devices to couple pairs of the first subset of the equipment terminals with the reference to the second subset of the equipment terminals, and coupling a reference wire to the trace and the enclosure.

13. The method as claimed in claim 12 wherein mounting the circuit board in an enclosure with other equipment includes coupling the reference wire to an electrical ground reference node.

14. A cross connect panel, comprising:
a circuit board configured with input connectors and output connectors on an equipment side of the circuit board;
a trace on the circuit board coupled to a first subset of equipment terminals on the input connectors and output connectors to provide a reference to the first subset of the equipment terminals; and
a means for cross connecting a field of user-configurable assignment terminals on a user side of the circuit board to enable a user to cross connect selectively a second subset of the equipment terminals on the input connectors and output connectors.

15. The cross connect panel as claimed in claim 14 wherein the input connectors and output connectors include wire wrap pins.

16. The cross connect panel as claimed in claim 14 wherein the input connector is coupled to an equipment monitoring device that is configured to generate an alarm signal, the output connector is coupled to an equipment status transport device, the cross connect field is configured to route an alarm signal transmitted by the equipment monitoring device to the equipment status transport device and wherein the equipment status transport device is configured to report the alarm signal to a management node or to generate an alarm signal.

17. The cross connect panel as claimed in claim 14 wherein the user-configurable assignment terminals provide more connection points with a larger pitch than user-configurable assignment terminals in an absence of the input connectors and output connectors and the means for tracing that is configured to provide a reference to the first subset of equipment terminals.

18. The cross connect panel as claimed in claim 14 mounted in an enclosure with other equipment which includes devices electrically configured to couple pairs of the first subset of equipment terminals with the reference to the second subset of equipment terminals and a reference wire coupled to the trace and the enclosure.

19. The cross connect panel as claimed in claim 18 wherein the enclosure includes an electrical ground reference node, and wherein the reference wire is coupled to the electrical ground reference node.
